(19) United States
(12) Patent Application Publication
(10) Pub. No.: US 2010/0119722 A1
(43) Pub. Date: May 13, 2010

(54) DECORATION METHOD AND SYSTEM FOR DECORATING CERAMIC PRODUCTS

(75) Inventor: Fausto Tarozzi, Formigine (Modena) (IT)

Correspondence Address: TUTUNJIAN + BITETTO, P.C., 20 CROSSWAYS PARK NORTH, SUITE 210, WOODBURY, NY, 11797, US

(73) Assignee: SITI B&T GROUP S.P.A., Formigine (Modena) (IT)

(21) Appl. No.: 12/596,328

(22) PCT Filed: Apr. 15, 2008
(86) PCT No.: PCT/IB08/00917

§ 371 Date: Oct. 16, 2009

(30) Foreign Application Priority Data
Apr. 17, 2007 (IT) MO2007A000134

(51) Int. Cl. B05D 1/02; B05B 3/00

(52) U.S. Cl. 427/424; 118/323; 901/43

(57) ABSTRACT

A decoration method and system, suitable for decorating, with a decorator unit, multiform ceramic products having multiform surfaces to be decorated, includes moving the multiform products and/or the decorator unit relative to each other with a movement device such that the decorator unit follows the multiform surfaces to be decorated. Decorating substances are dispensed with a dispensing device, which is moveable in space.

### TECHNICAL FIELD

The invention refers to a decoration method and system for decorating ceramic products, particularly products with multiform concave and convex surfaces, such as, e.g., sanitary ware.

### TECHNOLOGICAL BACKGROUND

Many types of systems are known to exist for decorating ceramic products such as tiles and sanitary ware.

Recently, one of the most commonly used decorating techniques for decorating flat-shaped ceramic products, such as tiles and slabs, has been the procedure known as “ink jet”, which is a procedure normally used in the printers connected to computers for printing wording and designs on sheets.

According to this technique, one or more colored ink dispensing heads are supported by a frame normally positioned above a product conveyor line. The dispensing heads are connected to their own tank and each has a series of nozzles through which the inks are dispensed that have to be deposited on the visible surfaces of the tiles or the slabs to form a preset design while these run under the frame, conveyed by the conveyor.

The dispensing heads are fixed or positionable in fixed positions on the frame in cross directions with respect to the direction of forward movement of the tiles and both the successions and the durations of the ink dispensing operations are coordinated by an electronic control program, according to the designs that have to be reproduced.

### SUMMARY

This state of the art has a number of drawbacks.

A first drawback is that it is only possible to decorate flattened products, meaning products that have a flat surface, such as ceramic tiles and slabs.

Another drawback is that when the products to be decorated, e.g., the new tiles or slabs, are of very large dimensions, the use is required of a proportionately high number of dispensing heads to be able to quickly decorate the entire surface.

This large number of heads creates a further drawback, which is the difficulty in coordinating the functions of each single dispensing head with respect to the others.

One object of the invention is to upgrade the state of the art.

Another object of the invention is to develop a decoration method and system for decorating ceramic products that also permits using the ink jet technique for products with multiform surfaces, such as, e.g., sanitary ware.

A further object of the invention is to develop a decoration method and system for decorating ceramic products that does not create problems with regards to the coordination of the decorating phases.

According to one aspect of the invention, a decoration method is provided for decorating multiform ceramic products having multiform surfaces to be decorated, characterized by the fact that it comprises: moving said multiform products and/or said decorator unit with respect to each other in such a way that said decorator unit follows said multiform surfaces to be decorated; dispensing decorating substances during said movement.

According to another aspect of the invention, a decoration system is provided for decorating ceramic products, suitable for decorating multiform: products having multiform surfaces to be decorated, comprising: a dispensing unit of decorating substances; a supporting and movement device for said dispensing unit; characterized by the fact that said supporting and movement device comprises movement means for moving in space said dispensing unit along said multiform surfaces.

The decoration method and system for decorating ceramic products therefore permit making decorations according to a preset design on products that have multiform surfaces and without there being coordination difficulties between the decoration phases.

### BRIEF DESCRIPTION OF THE DRAWINGS

Further characteristics and advantages of the invention will appear more evident from the detailed description of a decoration method and system for decorating ceramic products, illustrated indicatively by way of non limiting examples in the accompanying drawings, wherein:

FIG. 1 is an interrupted schematic view of a decoration system for decorating flat-shaped ceramic products according the known technique;

FIG. 2 is an interrupted and schematic side view of a decoration system for decorating ceramic products having multiform surfaces;

FIG. 3 is a detailed view of a dispensing unit of decorating substances, in a second possible embodiment.

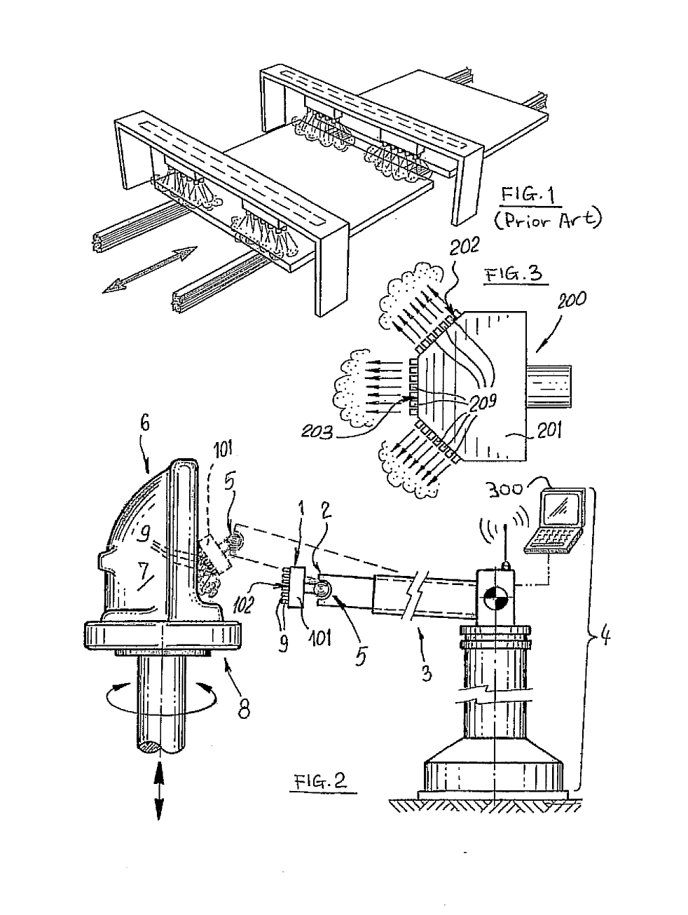

### EMBODIMENTS OF THE INVENTION

With reference to the FIG. 2, a dispensing head 1 can be seen that is supported at a distal end 2 of an arm 3 of a robot 4.

The coupling of the dispensing head 1 has been schematically illustrated with an articulated ball joint 5 for the purpose of indicating that the dispensing head 1 can be moved in space without any limit with regard to direction, driven in a way known to a person skilled in the field. In FIG. 2, a piece of sanitary ware 6 has been shown, in this specific case a washbasin 7, installable on a support 8.

This support 8 can be fixed or movable, so as to arrange the washbasin 7 turned towards the dispensing head 1 in positions that make decorating the latter easier.

As can be further seen in the FIG. 2, the dispensing head 1 comprises a substantially parallelepiped body 101 having a flat face 102 considered frontal, which has a plurality of sprayer nozzles 9 that can be turned towards the washbasin 7 and ready to dispense ink or glaze jets towards the multiform surfaces of this.

The FIG. 3 on the other hand shows a second embodiment of the dispensing head, indicated by 200.

This dispensing head 200 comprises a prismatic body 201 that defines a series of faces 202, 203, 204 angled the one with the other and on which are fixed a plurality of sprayer nozzles 209.

This way, the ink or glaze sprays can be directed in different directions and the angles allow the head 201 to also more easily reach hidden points of the multiform surfaces of the products.

For a person skilled in the field, it is simple to arrange the angled surfaces according to preferred angles or contemplate for the surface on which are arranged the plurality of nozzles 209, a cap form, with ellipsoid round profile or according to other convex and concave shapes, to arrange the sprayer nozzles 209 according to required positions. Each sprayer nozzle 9 or 209 is connected independently to one or more ink or glaze storage tanks, normally so it is independent of the other sprayer nozzles 9 and 209.

Furthermore, an electronic program entered in a computer 300 sets and controls both the movement directions of the dispensing head 1 or 201 and the parameters concerning the inks or the glazes to regulate the quantity, the spraying pressure, the speed and the density for each nozzle 9 or 209, depending on the position of this in space and, therefore, on the distance from the multiform surface of the piece of sanitary ware 6 to be decorated, so as to prevent the formation of drops of excess glaze creating undesired drips. The decoration method comprises positioning a product, e.g., a washbasin 7, in such a position that every point of its multiform surfaces can be reached by the ink or glaze sprays dispensed by the dispensing nozzles 9 or 209.

In other words, according to the decoration method, and with the decoration apparatus, the dispensing head 101 or 201 can be moved in space with respect to the washbasin 7 by means of the arm 3 of the robot 4, or the washbasin 7 can be moved with respect to the dispensing head 101 or 201, or both can be moved with respect to one another. In all cases, the movements of the dispensing head 101 or 201 and/or of the washbasin 7 allow the sprayer nozzles 9 or 209 to spray glazes and inks in a calibrated way keeping preset distances with respect to the multiform surfaces to be decorated, so as to execute preset designs without the formation of drops.

The arm 3 of the robot 4, which can be of the extensible type, e.g., telescopic, supports and moves the dispensing head 101 or 201 in space, causing it to follow the profiles of the multiform surfaces to be decorated so that the front face 102 or one of the faces 202, 203, 204 is turned towards a multiform surface to be decorated and maintains a substantially constant distance from this, being also able to penetrate inside cavities, as schematically indicated in the FIG. 2 by broken lines.

The computer 300 stores the designs to be executed and, if necessary, a plurality of dispensing heads 101 or 201 can be contemplated, each supported by its own operating arm 3 of a robot 4, all controlled by the computer 300 which coordinates their movements, the ink and glaze sprays and all the characteristics relating to their operation.

1. Decoration method suitable for decorating, with a decorator unit, multiform ceramic products having multiform surfaces to be decorated, comprising: moving said multiform products and/or said decorator unit with respect to each other such that said decorator unit follows said multiform surfaces to be decorated; and dispensing decorating substances during said movement.

2. Method according to claim 1, wherein during said dispensing controlling parameters of said substances, in such a way as to adapt said dispensing to said multiform surfaces.

3. Method according to claim 1, wherein said multiform ceramic products are chosen among sanitary wares, crockery and dishes.

4. Method according to claim 1, wherein said moving comprises following at preset distances profiles of said multiform surfaces to be decorated.

5. Method according to claim 1, wherein said dispensing comprises spraying with at least one sprayer nozzle fitted on said decorator unit.

6. Method according to claim 2, wherein said controlling comprises setting and verifying at least one of density, temperature, spraying pressure, volume, and spraying speed values of said decorating substances.

7. Method according to claim 1, wherein said moving comprises moving said decorator unit with respect to said multiform ceramic products which remain fixed.

8. Method according to claim 1, wherein said moving comprises moving said multiform ceramic products with respect to said decorator unit which is maintained fixed.

9. Method according to claim 1, wherein said decorator unit comprises a plurality of sprayer nozzles fitted on said decorator unit.

10. Method according to claim 9, wherein each sprayer nozzle of said sprayer nozzles can be fed with said decorating substances independently of other sprayer nozzles.

11. Method according to claim 9, wherein said plurality of sprayer nozzles is fitted on a decorating head which is moveable in space.

12. Decoration apparatus suitable for decorating multiform products having multiform surfaces to be decorated, comprising: a dispensing unit for decorating substances; a supporting and movement device for said dispensing unit, wherein the supporting and movement device comprises movement means for moving in space said dispensing unit along said multiform surfaces.

13. Apparatus according to claim 12, wherein said supporting device comprises a robot.

14. Apparatus according to claim 13, wherein said movement means comprises an operating arm fitted on said robot, to supported said movement means in space.

15. Apparatus according to claim 12, wherein said dispensing unit comprises a decorating head fitted at a free end of said operating arm and defining a face faceable on said multiform surfaces according to preset directions; a plurality of sprayer nozzles arranged on said face; and feeding means of said plurality of nozzles.

16. Apparatus according to claim 15, wherein said decorating head comprises a plurality of faces angled relative to one another to face said multiform surfaces, said faces being arranged with said plurality of sprayer nozzles.

17. Apparatus according to claim 15, wherein said decorating head comprises a substantially round convex face faceable to said multiform surfaces, on said face being arranged said plurality of sprayer nozzles.

18. Apparatus according to claim 15, wherein each sprayer nozzle of said plurality of sprayer nozzles is fed independently of other sprayer nozzles with feeding means of said decorating substances.
